(19) United States
(12) Patent Application Publication
(10) Pub. No.: US 2023/0196898 A1
(43) Pub. Date: Jun. 22, 2023

(54) Power Supply Unit Including an Integrated Processing Unit for Installation in a Commercial Vehicle System

(71) Applicant: Anderson Connectivity, Inc., Melbourne, FL (US)

(72) Inventors: Christopher Snyder, Melbourne, FL (US); Brian David Anderson, New Smyrna Beach, FL (US); Stephen C. Meyer, Palm Bay, FL (US); Kevin Wynn McElroy, Satellite Beach, FL (US)

(73) Assignee: Anderson Connectivity, Inc., Melbourne, FL (US)

(21) Appl. No.: 17/948,466

(22) Filed: Sep. 20, 2022

Related U.S. Application Data
(60) Provisional application No. 63/292,099, filed on Dec. 21, 2021.

(51) Int. Cl. G08B 21/18; G06Q 50/26; H04B 7/185; G06V 40/16; G06T 1/20; G06V 20/52

(52) U.S. Cl. CPC G08B 21/182; G06Q 50/265; H04B 7/18517; G06V 40/172; G06T 1/20; G06V 20/52

(57) ABSTRACT

A power supply unit may include a power supply interface, a first interface, a second interface, an input/output (I/O) interface, and a graphics processing unit (GPU). The power supply receives a power supply from a transport vehicle. The first interface is communicatively coupled to a short-range network associated with the transport vehicle. The second interface is coupled to one or more of K, Ka, or KU-band antennas to communicate with one or more of a satellite or a base station. The I/O interface is coupled to one or more sensors. The GPU is coupled to the power supply interface, the first interface, the second interface, and the I/O interface. The GPU may receive data from the one or more sensors, determine an alert based on the received data, and send the alert to one or more computing devices via one or more of the first interface or the second interface.

### FIELD

The present application is a non-provisional of and claims priority to U.S. Provisional Patent Application No. 63/292,099 filed on Dec. 21, 2021 and entitled “Power Supply Unit Including an Integrated Processing Unit”, which is incorporated herein by reference in its entirety.

### FIELD

The present disclosure is generally related to satellite communications equipment, and more particularly to a power supply unit (PSU) including an integrated processor that may be installed in a public vehicle configured for terrestrial, water, or aerial transportation of people or goods, such as an airplane, a bus, a train, a ship, a ferry, or any combination thereof. The present disclosure is related to a PSU that may be configured to capture information from one or more of a sensor, a system, or a device and that may be configured for pattern recognition to identify one or more data points that may be trigger generation of one or more alerts.

### BACKGROUND

Satellite communication equipment that is mounted to airplanes, for example, may be used to provide a broadband Internet link that can be used for data, video, and voice communications. Generally, the broadband service is primarily used for passenger communications and in-flight entertainment but is also available for aircraft information systems.

Aeronautical Radio, Incorporated (ARINC), established in 1929, was a major provider of transport communications and systems engineering solutions for eight industries: aviation, airports, defense, government, healthcare, networks, security, and transportation. ARINC had installed computer data networks in police cars and railroad cars and also maintains the standards for line-replaceable units. Since 2018 when Rockwell Collins acquired ARINC, ARINC has operated as part of Collins Aerospace.

ARINC has established a Ku-Band and Ka-Band subcommittee to develop standards for broadband satellite system hardware and aircraft installation provisions, which are currently defined in ARINC Project Papers 791 and 792. The Ku-Band and Ka-Band satellite communication equipment standards provide airlines with freedom of choice for their Internet gateway service providers and their associated equipment, enabling a wide variety of service offerings with dedicated equipment that would otherwise require custom installation.

### SUMMARY

Embodiments of systems, methods, and devices are described below that may include a power supply unit (PSU) that include a processing unit and that may be coupled to or integrated within the dedicated network communications equipment of a transport vehicle. Depending on the implementation, the PSU may be configured to provide in-transit communications, entertainment, or both for passengers and in-transit monitoring of systems and devices. The PSU may be configured to support Ku-band, Ka-band or K-band satellite communications between the transport vehicle and a network base station or a satellite. The PSU may also be configured to support local area network communications within the transport vehicle. In some implementations, such devices may be qualified by an associated governmental agency (such as the Federal Aviation Administration, the National Transportation Safety Board, or another agency) for integration into the onboard systems.

In some implementations, the PSU may operate as a data aggregator and a reporting device. As a data aggregator, the PSU may be configured to capture data from systems, devices, and components (including sensors) of the transport vehicle, to correlate the captured data with date, time, and physical location information, and to store the correlated data in a memory. As a reporting device may be configured to provide the captured data to an analytics system through a communications network via one or more antennas of the communication system during transit or when the vehicle reaches a depot, which may include a stop location, such as a port, a passenger gate, an overnight hub, or other stop location for the transport vehicle. Such systems, devices, and components may include sensors (optical, radio frequency (RF), pressure, weight, door sensors, temperature sensors, pressure sensors, fuel sensors, engine sensors, position sensors, orientation sensors, motion sensors, altitude sensors, and other sensors), computing systems, antenna systems, vehicle components, control systems, motors, thermal sensors, and other systems, other devices, or any combination thereof. In some implementations, optical sensors may include cameras, infrared sensors, radiant temperature sensors, or other sensors that may be configured to provide non-intrusive biometric sensor data. In some instances, the PSU may communicate captured data to a computing system associated with a depot-level maintenance facility so that the maintenance facility may have advanced notice of a part or system in need of disassembly, inspection, repair, rebuilding, replacing, repainting, other servicing, or any combination thereof.

In some implementations, the PSU may include a circuit including one or more input/output (I/O) interfaces, one or more communications interfaces, a graphics processing unit (GPU), and one or more memory devices. The memory may be configured to store data, processor-readable instructions, thresholds, other settings, or any combination thereof. The one or more I/O interfaces may be coupled to one or more sensors, one or more systems, one or more devices, or any combination thereof that may be associated with a vehicle. The PSU may be configured to capture data from the various sensors, systems, and devices and may store the data in the memory. In some implementations, the PSU may be configured to communicate the captured data to one or more external computing systems via the one or more communications interfaces. The PSU may communicate the captured data in response to a request, at pre-determined intervals, when the system establishes a communications link with a communications network, in response to a user-selection, or any combination thereof. In some implementations, the PSU may be configured to analyze the captured data and to selectively generate alerts based on the analysis.

Unlike conventional power supply units that are configured only to supply power to radio frequency antenna components of a transport vehicle, the PSU may be configured to provide one or more additional functions that may be unrelated to power delivery and that may not be defined by the ARINC standards or by other standards for RF communications on transport vehicles. The PSU may include a first interface coupled to a short-range communications network associated with the transport vehicle and a second interface coupled to one or more radio frequency antennas associated with the transport vehicle that are configured to communicate with one or more of a satellite or a base station. The PSU may include an input/output interface coupled to one or more sensors or systems associated with the transport vehicle, a graphics processing unit (GPU), and a memory configured to store data and processor-readable instructions. The GPU may be configured to receive data from the one or more sensors and to determine various parameters based on the received data. Such sensor data may include optical data, thermal data, chemical data, radiation data, errors, service data, other data, or any combination thereof. In some implementations, the GPU receive data from the one or more sensors, determine one or more parameters based on the received data, determine an alert based on the one or more parameters, and send the alert to one or more computing devices through one or more of the short-range communications network or the one or more radio frequency antennas.

In some implementations, a PSU may include a power supply interface, a first interface, a second interface, an input/output (I/O) interface, and a graphics processing unit (GPU). The PSU receives a power supply from a transport vehicle. The PSU may be configured to provide filtering and other operations to clean up the vehicle-supplied power to be usable and qualifiable so that the PSU can pass qualification for inclusion on airplanes and other regulated transport vehicles. The first interface is communicatively coupled to a short-range network associated with the transport vehicle. The second interface may be coupled to one or more radio frequency antennas to communicate with one or more of a satellite or a base station. The I/O interface is coupled to one or more sensors. The GPU is coupled to the power supply interface, the first interface, the second interface, and the I/O interface. The via one or more of the first interface or the second interface.

In other implementations, a power supply unit may include a power supply interface, a first interface, a second interface, one or more I/O interfaces, and a GPU. The power supply interface may include a power management unit and may be configured to receive a power supply from a transport vehicle. The first interface may be coupled to one of the one or more power supply buses and may be communicatively coupled to a short-range communications network associated with the transport vehicle. The second interface may be coupled to one or more radio frequency antennas configured to communicate with one or more of a satellite or a base station. The I/O interface may be coupled to one or more sensors or systems of the transport vehicle. The power supply interface may aggregate characteristics, parameters, sensor data, service information, errors, and other data related to one or more systems of the transport vehicle. The GPU may be coupled to the power supply interface, the first interface, the second interface, and the I/O interface. The GPU may be configured to receive data from the one or more sensors, determine an alert based on the received data, and send the alert to one or more computing devices via one or more of the first interface or the second interface. The power supply interface may include a power management unit configured to control power provided to the first interface, the second interface, the I/O interface, and the GPU.

In still other implementations, a method may include receiving signals from one or more devices at a power supply unit (PSU) coupled to a transport vehicle. The signals may correspond to one or more parameters associated with the transport vehicle. The method may include determining one or more parameters from the received signals using a graphical processing unit (GPU) of the PSU. In some implementations, the GPU of the PSU may be configured to compare the one or more parameters to one or more of image data, temperature data, chemical data, or radiation data stored in a memory of the PSU. The method may include selectively generating an alert using the GPU based on the comparison and sending the alert to one or more computing devices via one or more of a first interface or a second interface. The first interface may be communicatively coupled to a short-range communications network associated with the transport vehicle. The second interface may be coupled to one or more radio frequency antennas configured to communicate with one or more of a satellite or a base station using one or more of a first range of frequencies from 12 to 18 gigahertz (GHz) defining a Ku Band, a second range of frequencies from about 18 to about 27 GHz defining a K Band, or a third range of frequencies from 26.5 to 40 GHz defining a Ka Band.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of a system including multiple transport vehicles, each of which may include a power supply unit (PSU) including an integrated processing unit, in accordance with certain embodiments of the present disclosure.

FIG. 2 depicts a block diagram of a system including multiple transport vehicles, each of which includes a PSU configured to communicate with an analytics system through a network, in accordance with certain embodiments of the present disclosure.

FIG. 3 depicts a block diagram of a system including an analytics system configured to receive data from a PSU associated with each of one or more transport vehicles through a network, in accordance with certain embodiments of the present disclosure.

FIG. 4 depicts a flow diagram of a method of providing captured data from the PSU to an analytics system, in accordance with certain embodiments of the present disclosure.

FIG. 5 depicts a flow diagram of a method of determining an alert based on optical data using a processing circuit of a power supply unit, in accordance with certain embodiments of the present disclosure.

FIG. 6 depicts a flow diagram of a method of determining an alert based on sensor data using a processing circuit of a power supply unit, in accordance with certain embodiments of the present disclosure.

FIG. 7 depicts a graphical interface that may be provided by an analytics system based on data from an on-board PSU, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the word “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

As used herein, the term “transport vehicle” refers to any vehicle designed, used, maintained, and licensed for carrying six or more fare paying passengers and optionally for carrying goods. In some implementations, the transport vehicle may be a public transport vehicle that is open to the public and that may operate according to a schedule. Public transport vehicles may include one or more of an airplane, a train, a bus, a subway, a ferry, a passenger ship, or another type of vehicular transportation. In some implementations, the transport vehicle may be a private or contract transport vehicle that may be reserved via a contract and that may transport passengers or goods on behalf of a private customer or business. Such private or contract transport vehicles may include vans, semi-trucks, cargo planes, cargo ships, other vehicles, or any combination thereof.

Embodiments of systems, methods, and devices are described below that may include a power supply unit (PSU) that may be coupled to or integrated within the dedicated network communications equipment. The PSU may be configured to provide in-transit communications, entertainment, or both for passengers, in-transit monitoring of systems and devices, and “last mile” monitoring of passengers and cargo. The PSU may be configured to support one or more of Ku-band, Ka-band, or K-band satellite communications between the transport vehicle and a network base station or a satellite. The PSU may also be configured to support local area network communications (such as IEEE 802.11x Wi-Fi and hardwired local area network (LAN) communications) within the transport vehicle. In some implementations, such devices may be qualified by an associated governmental agency (such as the Federal Aviation Administration, the National Transportation Safety Board, or another agency) for integration into the onboard systems.

The PSU may be configured to receive data from one or more of sensors, devices, or systems associated with one or more of a system, a device, a passenger, or cargo of the transport vehicle. The PSU may store the received data. In some implementations, the PSU may communicate the received data to one or more processing systems through selected communication paths. In some implementations, a GPU of the PSU may be configured to process the received data and to selectively generate an alert based on the received data. For example, the GPU may generate an alert when the received data exceeds one or more thresholds. In another example, the GPU may generate an alert when the received data resembles a pre-determined pattern, such as a correspondence to a pattern indicative of a problem, a match to a picture of a person, a match to a fingerprint, a resemblance to another pattern, or any combination thereof. In another example, the GPU may generate an alert when the received data includes an exception, an error code, a fault indicator, or another signal indicative of a problem. In some implementations, the PSU may be configured to monitor a last mile, detecting issues while in-transit, and selectively sending alerts to one or more computing devices indicative of the detected issues.

Embodiments of systems, methods, and devices are described below that may include a power supply unit (PSU) with an integrated processor configured to receive sensor data including one or more of optical data, thermal data, chemical data, or radiation data and to selectively determine an alert data based the sensor data. The integrated processor may include a graphics processing unit (GPU) or other processor capable of pattern recognition and parallel processing. In an example, the integrated processor may be configured to implement a neural network or other massively parallel data processing capability. In some implementations, the GPU may be configured to host machine learning algorithms or artificial intelligence algorithms that may be configured to analyze the sensor data to determine an alert.

In some implementations, a PSU may include a first interface coupled to a short-range communications network associated with a transport vehicle, a second interface coupled to one or more radio frequency antennas configured to communicate with one or more of a satellite or a base station, an input/output interface coupled to one or more sensors, and one or more processors (such as a graphics processing unit (GPU), or one or more other processors) configured to provide parallel processing and pattern recognition functionality. The GPU may be configured to receive data from the one or more sensors and to determine various alerts based on the received data. Such sensor data may include optical data, thermal (infrared, radiant temperature, etc.) data, chemical data, radiation data, other data, or any combination thereof. In some implementations, the GPU may send an alert to one or more of computing devices through one or more of the short-range communications network or the one or more radio frequency antennas.

In some implementations, the radio frequency antennas may be configured to send and receive data using a portion of the electromagnetic spectrum in the microwave range of frequencies from 12 to 18 gigahertz (GHz) defining a Ku-Band, using a portion of the electromagnetic spectrum in the microwave range of frequencies from about 18 to about 27 GHz defining a K-Band, or using a portion of the electromagnetic spectrum in the microwave range of frequencies in the range from 26.5 to 40 gigahertz (GHz) defining a Ka-Band. The radio frequency antennas may communicate data between the in-transit communications network of the transport vehicle and one of a satellite or a base station, or vice versa.

Embodiments of the PSU described herein may be integrated in onboard systems of a transport vehicle, such as an aircraft, and may be configured to provide last mile surveillance related to the monitoring of passengers, passenger items, cargo, or any combination thereof. For example, on departure, airport security may surveil each passenger from the time he or she approaches the airport until the time the door closes on the aircraft. Similarly, airport security may surveil each passenger from the time he or she exits the aircraft until he or she departs the airport. The PSU may provide surveillance functionality on the aircraft and in-flight, covering the “last mile” of the airline services. The sensors may be configured to capture optical data, which may be processed by a GPU within the PSU (or communicated by the PSU via the satellite antennas to a cloud system or to a ground-based system) for facial recognition functionality. Alternatively, or in addition, the sensors may be configured to capture thermal data (infrared data, radiant temperature data, or other non-intrusive temperature measurement data) associated with each passenger. In some instances, elevated thermal data (above 98.6 degrees Fahrenheit) may be indicative of a fever, which may provide a basis for removal of the passenger to prevent the spread of a contagious disease.

In some implementations, the sensors may capture optical data that is not visible to the human eye but that includes sufficient contrast information to be differentiated by further processing. Such optical data may include eye movements, transient facial expressions, gestures, or other motion data. In some implementations, the processor may be configured to determine heart rate data or other data based on almost imperceptible changes in skin color or movement of the skin determined from the optical data. Based on such data or on combinations of such data, the processor may determine or infer a person of interest and send an alert to one or more of onboard personnel or to security personnel.

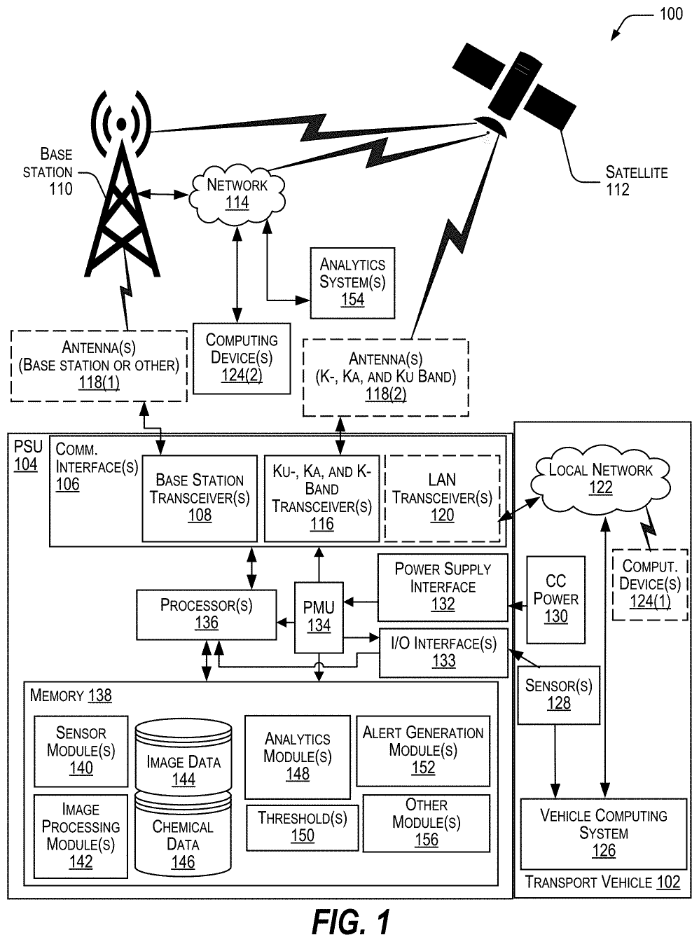

In some implementations, the one or more sensors may be arranged near one or more doors or passageways of the transport vehicle. In some implementations, the GPU within the PSU may be configured to receive optical data from the one or more sensors, compare the optical data to one or more images in a memory of the PSU using facial recognition techniques, and generate an alert when the optical data matches the one or more images. In an example, the stored images may include pictures of individuals on a “watch” list for law enforcement purposes or images of “very important persons” (VIPs) to be flagged for transit personnel, such as the flight attendants on a flight. In another example, the stored images may include pictures of missing children, which may be compared to optical data captured as passengers enter the transport vehicle. The PSU may generate an alert in response to determining a match to an image of a missing child. In some implementations, the PSU may be configured to receive thermal data from the one or more sensors (infrared, radiant, other non-contact sensors), compare the thermal data to one or more thresholds, and generate an alert when the thermal data exceeds the one or more thresholds. In some implementations, the PSU may be configured to receive chemical data from the one or more sensors, compare the chemical data from the sensors to chemical data within the memory, and generate an alert when the chemical data matches chemical data in the memory. In some implementations, the PSU may be configured to receive radiation data from the one or more sensors, compare the radiation data to one or more thresholds, and generate an alert when the radiation data exceeds the one or more thresholds. In some implementations, the PSU may receive optical data from the one or more sensors; process the optical data to determine one or more of motion data, heart rate data, or other data; and selectively generate an alert when patterns within the optical data indicate a potential threat. The PSU may send the alert to one or more computing devices via one or more of the short-range communications network of the transport vehicle or a wide area network via a satellite or base station. One possible implementation of a PSU is described below with respect to FIG. 1.

FIG. 1 depicts a block diagram of a system 100 including a transport vehicle 102 with a power supply unit (PSU) 104 including an integrated processing unit (one or more processors 136), in accordance with certain embodiments of the present disclosure. The transport vehicle 102 may be a shared passenger transportation service that is available for use by the public and that may operate according to a scheduled timetable. The transport vehicle 102 may include an airplane, a train, a bus, a ferry, a passenger ship, a cargo ship, a semi-truck, or another type of public transportation.

The transport vehicle 102 may include one or more sensors 128 configured to generate electrical signals based on one or more parameters associated with the transport vehicle 102, such as temperature, pressure, image data, sound data, passenger data, system data, device data, cargo data, other data, or any combination thereof. The one more sensors 128 may be configured to generate electrical signals indicative of the parameter to be sensed and to provide the electrical signals to the PSU 104. The one or more sensors 128 may include optical sensors, thermal (radiant, infrared, or other non-contact temperature) sensors, chemical sensors, radiation sensors, altitude sensors, orientation sensors, attitude sensors, position sensors, pressure sensors, motion sensors, radio frequency sensors, other sensors, or any combination thereof. In some implementations, the sensors 128 may include a geophysical sensor (such as a global positioning system circuit) configured to determine a geophysical position of the transport vehicle 102 based on radio frequency signals.

The transport vehicle 102 may include transport vehicle (CC) power 130, which may provide power for lights, doors, control systems (including the transport vehicle computing system 126), speakers, other systems and so on. The CC power 130 may also supply power to the PSU 104. In some implementations, the CC power 130 may be provided by batteries, power generation systems, other systems, or any combination thereof.

The PSU 104 may include one or more communications interfaces 106. The communications interfaces 106 may include one or more base station transceivers 108, which may be configured to communicate via one or more antennas 118(1) with a wide area network 114 through a base station 110. The base station 110 may be a cell site, cell tower, or base station that includes antennas and electronic communications equipment configured to receive radio frequency signals from smartphones as well as from Ku-band, Ka-band, and K-band transceivers 116 and to provide one or more cells within a wireless communications network to support communications by computing devices 124, such as smartphones, laptop computers, tablet computers, desktop computers, and other communications devices. The base station 110 may facilitate a communications link between a first computing device 124 and a second computing device 124 through a communications network 114, which may include cellular, digital, or satellite communications networks, the Internet, and so on. The communications network 114 may be communicatively coupled to other base stations 110, to satellites 112, and optionally to one or more other communications networks.

The communications interfaces 106 may include one or more of the K-band, Ka-band, or Ku-band transceivers 116, which may be configured to communicate with a satellite 112 (or a base station 110) via one or more antennas 118(2), which may be configured to send and receive data using one or more of a Ku-Band frequency, a K-Band frequency, or a Ka-Band frequency. The antennas 118 are depicted in dashed boxes because, in some implementations, the antennas 118 may be integrated with the PSU 104. In other implementations, the antennas 118 may be coupled to or integrated with the transport vehicle 102, and the PSU 104 may be configured to communicatively couple to the antennas 118. The Ku-Band may be within a portion of the electromagnetic spectrum in the microwave range of frequencies from 12 to 18 gigahertz (GHz). The K-Band may be within a portion of the electromagnetic spectrum in the microwave range of frequencies in the range from 18 to 27 GHz. The Ka-Band may be within a portion of the electromagnetic spectrum in the microwave range of frequencies in the range from 26.5 to 40 GHz.

The communications interfaces 106 may include one or more local area network (LAN) transceivers 120, which may communicate with one or more computing devices 124(1) and one or more transport vehicle computing systems 126 through a local network 122. The local network 122 may be provided and hosted by the LAN transceiver 120 of the PSU 104 or by the vehicle computing system 126 for passengers to access using their computing devices 124(1) for in-transit communications, entertainment, or both. In some implementations, the local network 122 may implement a short-range radio frequency network, which may support IEEE 802.11x (Wi-Fi or wired local area network), Bluetooth, or other short-range wireless protocols.

The PSU 104 may include one or more processors 136 coupled the communications interface 106 to receive data and instructions and to provide data to one or more computing devices 124(2) through the network 114. The PSU 104 may include a power supply interface 132 coupled to a CC power source 130 of the transport vehicle. The power supply interface 132 may include one or more connectors or pins configured to couple to the CC power source.

The PSU 104 may include a power management unit (PMU) 134 coupled to the power supply interface 132 to receive one or more of a current or a voltage supply. The

PMU 134 may be configured to distribute power to the communication interfaces 106, the one or more processors 136, a memory 138, and one or more input/output (I/O) interfaces 133. The memory 138 may include a non-volatile memory and may be configured to store data and processor-readable instructions. The one or more I/O interfaces 133 may include serial interfaces, parallel interfaces, connectors, ports, conductors, and other components configured to communicatively couple to one or more of the sensors 128 or the vehicle computing system 126 of the transport vehicle 102. In some implementations, the I/O interfaces 133 may include universal serial bus (USB) ports, other serial ports, bus connections, other connectors or ports, or any combination thereof.

The memory 138 may include one or more sensor modules 140 that may cause the processor 136 to receive sensor data from the one or more sensors 128. The sensor data may include optical data from one or more optical sensors, temperature data from one or more thermal sensors (radiant or infrared), chemical data from one or more chemical sensors, radiation data from one or more radiation sensors, other data, or any combination thereof. In some implementations, the sensor data may be indicative of one or more parameters of the transport vehicle 102.

The memory 138 may include one or more image processing modules 142 that may cause the processor 136 to process the optical data from the one or more sensors 128. In some implementations, the image processing modules 142 may cause the processor 136 to determine one or more data points within the optical data and to compare the optical data or the data points to images and associated data points determined from the images that were stored in image data 144 within the memory 138. In some implementations, the image processing module 142 may cause the processor 136 to identify correspondence between captured image data and stored image data to determine one or more matches. In some implementations, the image processing modules 142 may utilize a previously trained neural-net model to make predictions or inferences to provide facial recognition between the optical data from the sensors 128 relative to the image data 144. The image processing modules 142 may cause the processor 136 to determine one or more portions of an image that include one or more faces or portions thereof, to determine data that may be used for facial recognition from the one or more portions, and to compare the determined data to the image data 144. In some implementations, the image data 144 may be retrieved in real-time from the analytics systems 154, from law enforcement databases, from other sources, or any combination thereof. In some implementations, the image data 144 may be pushed to the PSU 104 from a source (such as the analytics system 154, law enforcement systems, or any combination thereof) via the network 114.

The memory 138 may include one or more analytics modules 148 that may cause the processor 136 to analyze the data received from the sensors 128 to determine chemical data, temperature data, pressure data, motion data, other data, or any combination thereof. In an example, the one or more sensors 128 may include at least one chemical sensor configured to determine chemical data. In some implementations, the analytics modules 148 may cause the processor 136 to compare chemical data from the sensors 128 to chemical data 146 stored in the memory 138. In some implementations, the analytics modules 148 may utilize a previously trained neural-net model to make predictions or inferences with respect chemical data from the sensors 128 relative to the chemical data 146. In some implementations, the chemical data 146 may be retrieved in real-time from the analytics systems 154, from law enforcement databases, from other sources, or any combination thereof. In some implementations, the chemical data 146 may be pushed to the PSU 104 from a source (such as the analytics system 154, law enforcement systems, or any combination thereof) via the network 114.

The analytics modules 148 may cause the processor 136 to compare other sensor data (such as temperature, pressure, or radiation measurements) from corresponding sensors of the one or more sensors 128 to one or more thresholds 150. In some implementations, the thresholds 150 may be programmable based on signals received from the analytics system 154.

The memory 138 may include one or more alert generation modules 152 that may cause the processor 136 to generate an alert, which may be sent to the transport vehicle computing system 126 via the local network 122, to an analytics system 154 via the network 114 through one or more of the base station 110 or the satellite 112, to one or more computing devices 124 through the local network 122 or the network 114, or any combination thereof. In an example, the alert may include a text message, a web page, an email, a phone call, another electronic message, or any combination thereof. The alert generation modules 152 may cause the processor 152 to generate an alert when the image processing module 142 determines a match between the optical data from the sensors 128 and the image data 144. In an example, the image data 144 may include images of persons of interest to law enforcement, for example, such as missing persons, wanted individuals, and so on. If the processor 136 determines a match, the alert generation module 152 may cause the processor 136 to send the alert to one or more of the computing system 126, the analytics system 154, the computing devices 124. In this example, the alert may include the captured optical data, the matched image from the image data 144, and related text. In some implementations, the analytics system 154 may be configured to verify the match and to notify local law enforcement.

In some implementations, the analytics system 154 may be configured to present a visual representation of the source of the alert. For example, if the alert is based on a sensor reading associated with a system or component of the transport vehicle 104, the analytics system 154 may present a graphical interface including one or more images of the transport vehicle 104, the system, or component. For example, a low pressure reading from one of the engines may cause the analytics system 154 to present a graphical interface including an image of the transport vehicle 104 with an indicator that visually identifies the engine associated with the sensor data.

The alert generation modules 152 may cause the processor 136 to generate an alert when the analytics modules 148 determine a match between chemical data from the sensors 128 and chemical data 146 in the memory 138. In an example, the sensors 128 may include one or more sensors 128 configured to detect the presence of one or more chemicals (identified within the chemical data 146), which may not be permitted in the transport vehicle. In another example, the chemical data 146 may include a list of chemicals of interest to law enforcement. For example, law enforcement may be investigating a spill event involving a particular chemical and may push the chemical information to the PSU 104 to update the chemical data 146 in order to utilize the PSU 104 to identify passengers who were exposed to the chemical and who may be witnesses. Depending on the detected chemicals, the alert generation module 152 may cause the processor 136 to send the alert to the transport vehicle computing system 126, to the analytics system 154, to other computing devices 124, or any combination thereof. In some instances, the processor 136 may send the alert to a computing device 124 associated with law enforcement, via the network 114.

The alert modules 152 may cause the processor 136 to generate an alert when the analytics modules 148 determine that the temperature data for a passenger as determined by the one or more sensors 128 exceeds one or more thresholds, which may indicate that the passenger has a fever. In an example, the one or more sensors 128 may include radiant sensors configured to determine a temperature of the passenger, which may be indicative of illness, such as COVID-19 or other illnesses. Since fever is a potential indicator of infection, the alert modules 152 may cause the processor 136 to send the alert from the transport vehicle computing system 126 or to the analytics system 154 or other computing devices 124, such as a computing device 124 associated with law enforcement, via the network 114.

In some implementations, the one or more sensors 128 may include at least one radiation sensor, which may be configured to generate signals indicative of the presence of radiation associated with a passenger. The one or more sensors 128 may also include one or more optical sensors to capture image data corresponding to the passenger. The alert generation modules 152 may cause the processor 136 to generate an alert and to send the alert to one or more of the transport vehicle computing system 126 via the local network 122 or to the analytics system 154 or other computing devices 124 through the network 114. It should be appreciated that radiation may be indicative of a passenger who recently received radiation treatment for cancer or other health issues. Alternatively, the radiation may be indicative of a passenger who works with radioactive materials. Other implementations are also possible.

The memory 138 may include one or more other modules 156 that may cause the processor 136 to perform other operations. In some implementations, the various modules may operate to receive sensor data from one or more sensors 128 and to enable the PSU 104 to determine parameters that may be indicative of an event that should be brought to the attention of personnel of the transport vehicle 102, to other individuals, or optionally to law enforcement personnel.

The PSU 104 may provide a number of advantages over conventional power supply units. First, the PSU 104 may include standard interfaces for coupling to the antenna subsystem for the one or more antennas 118 (K-band, Ka-band, Ku-band, other antennas, or any combination thereof) and standard interfaces for coupling to or providing the local network 122 of the transport vehicle 102. The standard interfaces enable rapid installation of the PSU 104.

Second, the PSU 104 includes one or more processors 136, such as a graphics processing unit (GPU), which may enable pattern recognition and advanced analytics in real-time. By integrating the GPU, the PSU 104 may be configured to perform complex analytics based on sensor data. Such complex analytics may include pattern recognition (e.g., facial recognition based on optical data, predictive analytics based on data from a combination of sensors 128, and so on). Alternatively, the GPU may be configured to compare sensor data to various thresholds 150, to chemical data 146, to image data 144, and so on.

Additionally, by integrating the PSU 104 with the power supply associated with the communication systems of the transport vehicle 102, the PSU 104 cannot be readily disabled without accessing the internal systems of the transport vehicle. Second, by integrating the processing capabilities within a PSU 104 that is integrated into the communication systems, the processing of the PSU 104 cannot be easily compromised by hacking. The PSU 104 is wired into the systems and does not operate as a device on the network 122 that might be discovered by a hacker. Other advantages may also be readily apparent to workers skilled in the art.

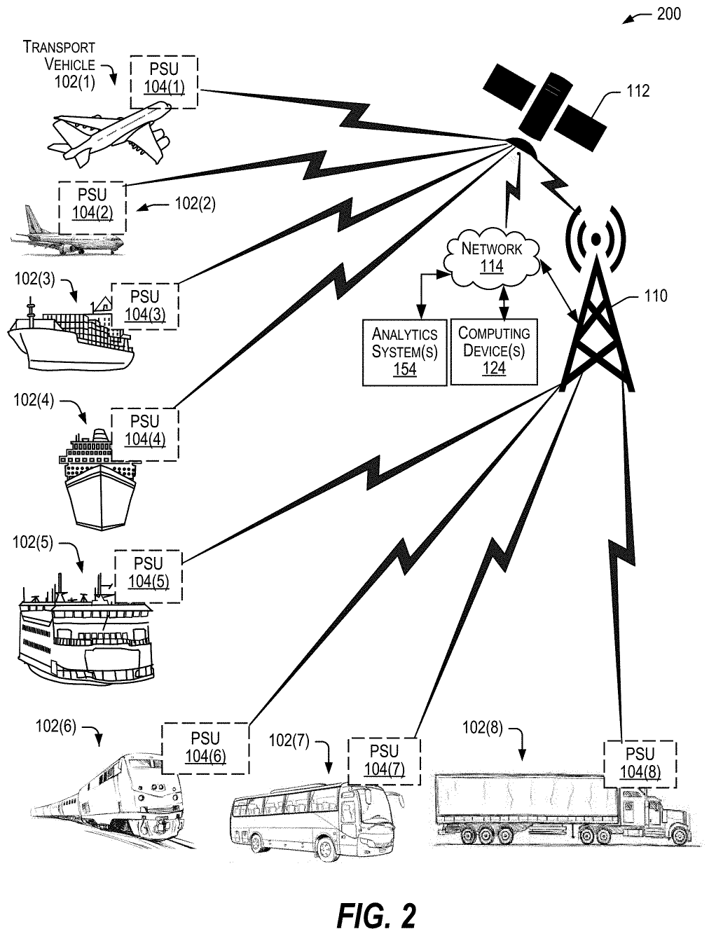

The transport vehicle 102 with a PSU 104 having an integrated processor 136 may implemented in a variety of form factors. For example, the transport vehicle 102 may be a bus, a train, a ferry, an airplane, a passenger ship, a cargo ship, a semi-truck, or another type of transport vehicle. Some illustrative, non-limiting examples, of transport vehicles 102 are described below with respect to FIG. 2.

FIG. 2 depicts a block diagram of a system 200 including multiple transport vehicles 102, each of which includes a PSU 104 configured to communicate with an analytics system 154 through a network 114, in accordance with certain embodiments of the present disclosure. In this example, the transport vehicle 102(1) may be an aircraft in flight, which may provide an in-transit network for communication and entertainment, and which may provide a connection to the Internet or to a proprietary network via a communications link to one or more satellites 112. The one or more sensors 128 may capture sensor data at doors (exit doors, bathroom doors, cockpit doors, etc.) or common passage areas (the main aisle or waiting areas near the cockpit or bathrooms) of the aircraft (transport vehicle 102(1)) during the flight. In some implementations, the one or more sensors 128 may be configured to capture sensor data in response to movement of a passenger near one of the one or more sensors 128. The PSU 104(1) may receive the sensor data from the sensors 128 and may process the sensor data to determine one or more of a match (optical or chemical) or a parameter (temperature or radiological) that exceeds a threshold. If a match or a parameter exception are detected, the PSU 104(1) may generate an alert that may be communicated to onboard computing systems 126 (such as the computing interfaces within the cockpit), to the analytics system 154 or other computing devices 124 through the network 114 via the satellite 112. The one or more sensors 128 may also capture data in the cargo areas as well as data associated with components, devices, and systems of the transport vehicle 102(1). In some implementations, the PSU 104 may be configured to communicate one or more alerts to ground personnel while the transport vehicle 102 is in flight.

The transport vehicle 102(2) depicts an aircraft during boarding or during a deboarding process. In this example, the one or more sensors 128 may be configured to capture sensor data associated with each passenger as the passenger boards or deboards the aircraft or moves along the aisle and the PSU 104(2) may process the sensor data to determine one or more of a match (optical or chemical) or a parameter (temperature or radiological) that exceeds a threshold. If a match or a parameter exception are detected, the PSU 104(2) may generate an alert that may be communicated to onboard computing systems 126 (such as the computing interfaces within the cockpit), to the analytics system 154 or other computing devices 124 through the network 114 via the satellite 112. In some implementations, the PSU 104(2) may communicate stored sensor data to an analytics system 154 via a network 114 while the transport vehicle 104(2) is unloading passengers and cargo.

The system 200 may include transport vehicle 102(3) implemented as a cargo ship. The transport vehicle 102(3) may include sensors 126 configured to monitor the cargo as well as the systems, devices, and passengers of the transport vehicle 102(3). The PSU 104(3) may communicate captured data to the analytics system 154 through the network 114 in transit or when the transport vehicle 102(3) reaches port.

The transport vehicle 102(4) depicts a passenger ship in transit. In this example, the one or more sensors 128 may be configured to capture sensor data associated with each passenger as the passenger boards or deboards the ship or moves within common areas. The PSU 104(4) may process the sensor data to determine one or more of a match (optical or chemical) or a parameter (temperature or radiological) that exceeds a threshold. If a match or a parameter exception are detected, the PSU 104(4) may generate an alert that may be communicated to onboard computing systems 126 (such as the computing interfaces at the helm), to the analytics system 154 or other computing devices 124 through the network 114 via the satellite 112.

The transport vehicle 102(5) depicts a ferry in transit. In this example, the one or more sensors 128 may be configured to capture sensor data associated with each vehicle and at least some of the passengers during a boarding process, a deboarding process, or in transit. For example, the one or more sensors 128 may be positioned near entrances (stairs, bathrooms, or other entrances. The PSU 104(5) may process the sensor data to determine one or more of a match (optical or chemical) or a parameter (temperature or radiological) that exceeds a threshold. In some implementations, the PSU 104(5) may be configured to perform facial recognition operations to potentially match passengers to known threats via the image data 144. If a match or a parameter exception are detected, the PSU 104(5) may generate an alert that may be communicated to onboard computing systems 126 (such as the computing interfaces at the helm), to the analytics system 154 or other computing devices 124 through the network 114 via the satellite 112 or via the base station 110.

The transport vehicle 102(6) depicts a passenger train. In this example, the one or more sensors 128 may be configured to capture sensor data associated with each passenger as the passenger boards or deboards the train or moves along the aisle. The PSU 104(6) may process the sensor data to determine one or more of a match (optical or chemical) or a parameter (temperature or radiological) that exceeds a threshold. In some implementations, the PSU 104(6) may also monitor cargo carried by the transport vehicle 102(6). If a match or a parameter exception are detected, the PSU 104(6) may generate an alert that may be communicated to onboard computing systems 126 (such as the computing interfaces within the engine cabin), to the analytics system 154 or other computing devices 124 through the network 114 via the base station 110.

It should be appreciated that the train may also be implemented as a cargo train, and the sensors 128 may monitor various parameters associated with the cargo and associated with the systems and devices of the cargo train. The PSU 104 may be configured to determine alerts related to the cargo and to communicate the alerts to an analytics system 154 based on the sensor data.

The transport vehicle 102(7) depicts a commuter bus. In this example, the one or more sensors 128 may be configured to capture sensor data associated with each passenger as the passenger boards or deboards the bus or moves along the aisle. The PSU 104(7) may process the sensor data to determine one or more of a match (optical or chemical) or a parameter (temperature or radiological) that exceeds a threshold. If a match or a parameter exception are detected, the PSU 104(7) may generate an alert that may be communicated to onboard computing systems 126 (such as the computing interfaces associated with the driver's console), to the analytics system 154 or other computing devices 124 through the network 114 via the base station 110.

The transport vehicle 102(8) depicts a semi-truck (i.e., an 18-wheeler). In this example, the one or more sensors 128 may be configured to capture sensor data associated with cargo as the cargo is loaded onto the truck and to continue to monitor the cargo during transit. The PSU 104(8) may process the sensor data to determine one or more of a match (optical or chemical) or a parameter (temperature, position, radiological, or other data) that exceeds a threshold. If packages are shifting by more than threshold amounts during transit, the PSU 104(8) may send an alert to onboard computing systems 126 (such as the computing interfaces associated with the driver's console), to the analytics system 154 or other computing devices 124 through the network 114 via the base station 110 or via the satellite 112.

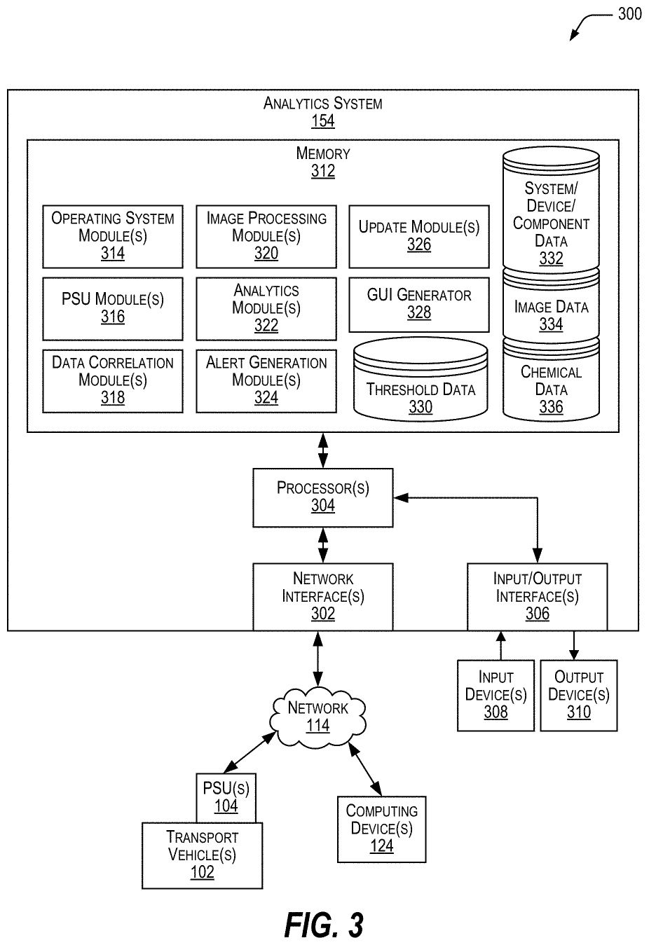

In the illustrated example, the transport vehicles 102 are provided for illustrative purposes and are not intended to be exhaustive of the possible transport vehicles 102 in which the PSU 104, the processor 136, and associated components (such as sensors 128) may be deployed. only and that other forms of transportation systems may also utilize the PSU 104 described herein. In some implementations, the PSU 104 may be configured to determine one or more of a match (optical or chemical) or a parameter (temperature or radiological) that exceeds a threshold and to generate an alert. In some implementations, the PSU 104 may be configured to determine patterns within the captured data. Such patterns may include facial recognition, combinations of sensor readings, and so on. In other implementations, the PSU 104 may be configured to perform initial processing and to report one or more of a preliminary match or preliminary parameter exception to the analytics system 154 for further processing, confirmation, and alert generation. An example in which the analytics system 154 performs such further analysis is described below with respect to FIG. 3.

FIG. 3 depicts a block diagram of a system 300 including an analytics system 154 configured to receive data from one or more transport vehicles 102 through a network 114, in accordance with certain embodiments of the present disclosure. The analytics system 154 may include one or more computing devices, which may be communicatively coupled through direct links or network connections through the network 114 to perform various analytic and alerting functions.

The analytics system 154 may include one or more network interfaces 302, which may be communicatively coupled to the network 114. The network interfaces 302 may send data, processor-readable instructions, or any combination thereof to the computing systems 126 of one or more transport vehicles 102 through the network 114 and via the associated one or more PSUs 104. The network interfaces 302 may also receive data from and send data, processor readable instructions, or any combination thereof through the network 114 to the one or more PSUs 104, which may be integrated in the one or more transport vehicles 102. The network interfaces 302 may also send data to and receive data from one or more computing devices 124 through the network 114.

The analytics system 154 may include one or more processors 304 coupled to the one or more network interfaces 302. The processors 304 may be configured to execute processor-readable instructions and to process data based on those instructions. The analytics system 304 may include one or more input/output (I/O) interfaces 306, which may include, or which may be coupled to one or more input devices 308 to receive input data and which may include or may be coupled to one or more output devices 310 to present output data. The input devices 308 may include one or more of a keyboard, a pointer device (a mouse, a stylus, a roller ball, a trackpad, or another pointer device), a touch-sensitive interface, a microphone, a camera, a scanner, or one or more other input devices. The output devices 310 may include one or more of a display, a speaker, a printer, or one or more other output devices.

The analytics system 154 may include a memory 312, which may include one or more of a hard disc drive, a flash drive, a solid-state drive, other non-volatile memory devices, or any combination thereof. The memory 312 may be configured to store processor-readable instructions, data, or any combination thereof. In the illustrated example, the memory 312 may store system/device/component data 332, image data 334, chemical data 336, threshold data 330, other data, or any combination thereof.

The memory 312 may include one or more operating system modules 314 that may be executed by the processor 304 to control operation of the various components. The operating system modules 314 may include drivers that may be executed by the processor 304 to manage operation of peripheral devices (such as the I/O interfaces 306, the network interfaces 302, and so on) and various components coupled to or integrated within the analytics system 154.

The memory 312 may include one or more PSU modules 316 that may cause the processor 304 to receive data from one or more PSUs 104. The PSU modules 316 may cause the processor 304 to determine an identifier associated with a particular PSU 104 from the received data. In some implementations, the identifier may include data that may be used to uniquely identify the associated transport vehicle 102.

The memory 312 may include one or more data correlation modules 318 that may cause the processor 304 to correlate the received data and the identifier and to store the correlated data as transport vehicle data 332 in the memory 312. The transport vehicle data 332 may be organized in a database or other data store, enabling the stored data to be searched and analyzed later. In some implementations, the data correlation modules 318 may correlate the received data to the transport vehicle 102, the date, the time, the physical location, other data values, or any combination thereof.

The memory 312 may include one or more image processing modules 320 that may cause the processor 304 to process the received data to extract optical data and to compare the extracted optical data to the already stored image data 334 to determine a match. In some implementations, the processing capabilities of the processor 304 may be greater than that of the processor 136 of the PSU 104, which may allow the image processing modules 320 to cause the processor 304 to analyze the optical data at a greater level of detail or to compare the optical data to multiple images of a person of interest to determine the match. In some implementations, the image processing modules 320 may utilize a previously trained neural-net model to make predictions or inferences to provide facial recognition functionality to determine a match between the optical data from the sensors 128 relative to the previously stored image data 334. In some implementations, the analytics system 154 may include a neural network, which may be trained using one or more data sets to perform facial recognition against a database of image data, such as the image data 334.

The memory 312 may include one or more analytics modules 322 that may cause the processor 304 to review the received data to determine a chemical match, a temperature that exceeds a temperature threshold, a radiation measurement that exceeds a radiation threshold, or any combination thereof. In some implementations, the analytics modules 322 may cause the processor 304 to determine optical data points within the captured data that may be compared to corresponding optical data points within the previously stored image data 334. In some implementations, the analytics modules 322 may utilize a previously trained neural-net model or a neural network to determine one or more matches between data from the sensors 128 and chemical data 336. In some implementations, the analytics module 322 may process one or more of the optical match data, the chemical match data, the temperature comparison data, or the radiation comparison data to determine associated reliability data.

In addition to processing the data or alerts received from the PSU 104, the analytics module 322 may cause the processor 304 to analyze the data over time to identify patterns. Such patterns may be used to predict service intervals for components, systems, and devices. For example, a transport vehicles 102 may experience a valve failure after a number of uses or miles. After replacement of the valve, the transport vehicle 102 may again experience a valve failure after a second number of uses or miles. The valve failure may be indicative of other issues that should be fixed and that, once fixed, may prolong the life of the valve. Alternatively, the valve failure may be predicted over time based on analysis of prior valve failures, enabling valve repair or replacement prior to failure or enabling scheduling of service for the transport vehicle 102 so that the depot can plan for the predicted repair.

The memory 312 may include one or more alert generation modules 324 that may cause the processor 304 to send alert data to one or more of the transport vehicle 102, the computing devices 124, or an output device 310. In an example, the alert may include a text message, a web page, an email, a phone call, another electronic message, or any combination thereof. In some implementations, the alert generation modules 324 may cause the processor 304 to send the alert to a display (output device 310) for review and verification by an operator prior to sending the alert to the transport vehicle 102 or a computing device 124. In some implementations, the alert generation modules 324 may cause the processor 304 to automatically send the alert to a computing device 124 associated with law enforcement. The alert may include determined sensor data related to the match or the parameter exception, information related to the transport vehicle 102 associated with the sensor data, reliability data, other data, or any combination thereof. In some implementations, the alert may include instructions to be followed by the individual receiving the alert. In some implementations, each type of alert may include a pre-defined template with the instructions, and the alert generation module 324 populates the template and then causes the processor 304 to send the populated template.

The memory 312 may include one or more update modules 326 that may cause the processor 304 to send updated processor-readable instructions to one or more of the PSUs 104 to update their respective functionality or operation or to adjust thresholds or other settings of the PSU 104. In some implementations, the one or more update modules 326 may push image data 334, chemical data 336, threshold data 330, or any combination thereof to the PSUs 104. The update modules 326 may be configured to keep the PSUs 104 up to date with respect to image data 334, chemical data 336, threshold data 330, or processor-readable instructions. In an example, image processing instructions of the image processing modules 142, analytics instructions of the analytics modules 148, image data 144, chemical data 146, thresholds 150, alert generation modules 152, and other modules 156 may be updated by the update modules 326 causing the processor 304 to send updated instructions, data, or both to the PSU 104.

In some implementations, the memory 312 may include other modules that may cause the processor 304 to perform other operations. Other implementations are also possible.

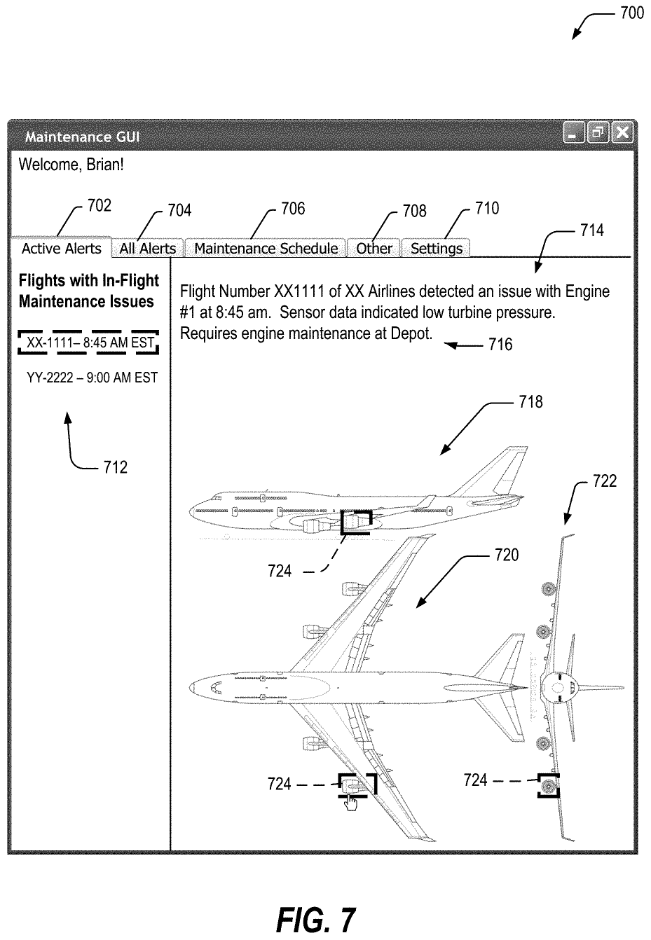

In the illustrated example, the memory 312 may include one or more graphical user interface (GUI) modules 328, which may be configured to cause the processor 304 to generate a graphical interface including data related to one or more of the PSUs 104. In some implementations, the GUI modules 328 may cause the processor 304 to generate a graphical interface including an image of at least a portion of the transport vehicle 102 and a visual pointer or indicator configured to identify a component, system, or device in need of service as determined based on data from the one or more sensors 128. An illustrative, non-limiting example of a graphical interface that may be generated by the GUI modules 328 is presented in FIG. 7

In some implementations, the analytics system 154 may receive an alert or other data from a PSU 104 using the PSU modules 316. The analytics system 154 may correlate the received alert or other data to the PSU 104 based on an identifier within the alert or other data using the data correlation modules 318 and may store the correlated information in the system/device/component data 332, the image data 334, the chemical data 336, or any combination thereof.

In some examples, the image processing modules 320 may determine a match between image data within the alert to image data 334 or between chemical data within the alert to chemical data 336. In other examples, the analytics modules 322 may compare receive data to one or more thresholds of the threshold data 330. The analytics modules 322 may also determine reliability factors for the matches or the comparisons and the thresholds 330 may include reliability thresholds. When the analytics modules 322 determine that a match exceeds or equals a reliability threshold or a comparison indicates a measured parameter exceeds or equals a threshold, the analytics system 154 may send an alert using alert generation modules 324. The alert may be sent to one or more of the transport vehicle computing system 126 of the transport vehicle or one or more computing devices 124. Other implementations are also possible.

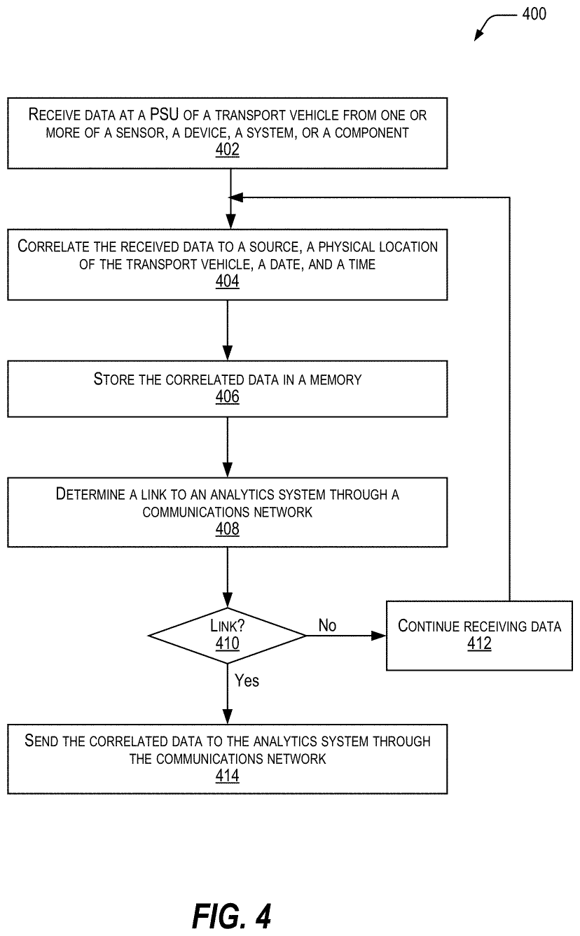

FIG. 4 depicts a flow diagram of a method 400 of providing captured data from the PSU 104 to an analytics system 154, in accordance with certain embodiments of the present disclosure. The PSU 104 may be coupled to or integrated within any of the transport vehicles 102 described with respect to any of the FIGS. 1-3. At 402, the method 400 may include receiving data at a PSU 104 of a transport vehicle 102 from one or more of a sensor 128, a device, a system, or a component. The system may include the vehicular system 126, which may include heating, air conditioning, and ventilation; vehicular radio communications; power systems; door systems, engine systems; and so on. The device may include a microwave, an oven, a refrigerator, a seat, or other integrated element that may be a subsystem of the larger device. The components may include parts or components of the larger systems and devices.

At 404, the method 400 may include correlating the received data to a source, a physical location of the transport vehicle, a date, and a time. In some implementations, the processor 136 of the PSU 104 may receive sensor data together with date data, time data, and other data. In this example, the processor 136 may correlate the received data to the physical location or position of the transport vehicle. Such information may include the geophysical location, the altitude, the attitude, the velocity, and so on.

At 406, the method 400 may include storing the correlated data in a memory. The PSU 104 may store the correlated data in the memory 138, for example, as image data 144, chemical data 146, or other data.

At 408, the method 400 may include determining a link to an analytics system 154 through a communications network 114. The PSU 104 may attempt to establish, authenticate, and secure a communications link to the analytics system 154 through the network 114. In transit, the PSU 104 may be unable to establish a communication channel or may restrict its own communications to avoid consuming bandwidth that may be needed to service the network usage of the passengers of the transport vehicle 102.

At 410, if a link is not established, the method 400 may include continuing to receive data, at 412. The data may be received from one or more sensors, devices, systems, or components of the transport vehicle 102. The method 400 may then return to 404 to correlate the received data.

Otherwise, if no link is established at 410, the method 400 may include sending the correlated data to the analytics system 154 through the communications network 114, at 414. In some implementations, the PSU 104 may encrypt the captured data prior to sending the captured data to the analytics system 154.

In some implementations, the correlated data may be sent together with or as part of an alert, which may be processed by the analytics system 154. In other implementations, the PSU 104 may send the correlated (raw) data to the analytics system 154, which may process the raw data to determine one or more exceptions. In still other implementations, the PSU 104 may send an alert and the raw data to the analytics system 154, which may process and confirm (or reject) the alert based on the raw data. Other implementations are also possible.

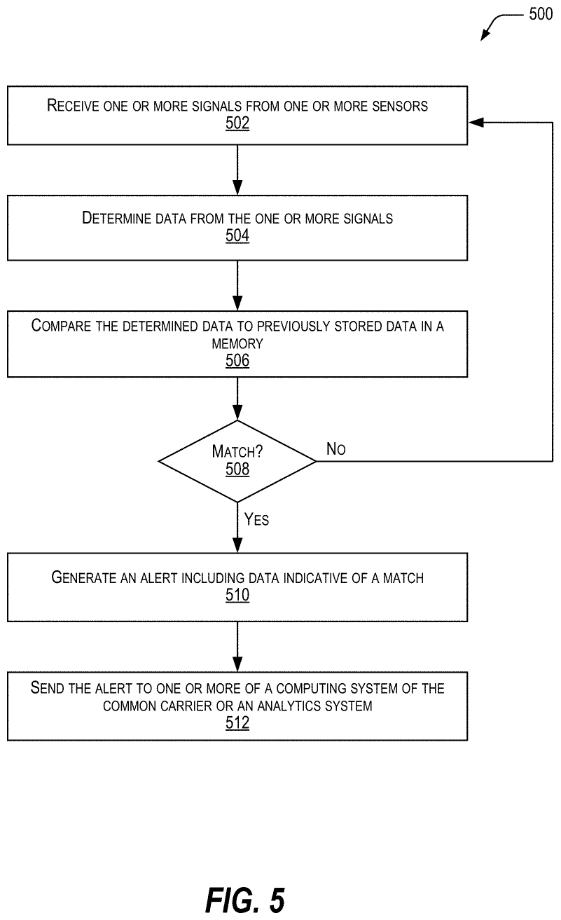

FIG. 5 depicts a flow diagram of a method 500 of determining an alert based on optical data using a processor of a PSU 104, in accordance with certain embodiments of the present disclosure. At 502, the method 500 may include receiving one or more signals from one or more sensors. In some implementations, a PSU 104 may include a processor 136 that is configured to receive signals from the one or more sensors 128, which are associated with one or more areas of a transport vehicle 102, such as an airplane, a ship, a ferry, a train, a bus, or another type of transport vehicle 102.

At 504, the method 500 may include determining data from the one or more signals. In some implementations, the one or more sensors 128 may include an optical sensor configured to generate signals including optical data, which may be received and processed by the processor 136 of the PSU 104. In some implementations, the one or more sensors 128 may include one or more chemical sensors configured to generate signals indicative of the presence of one or more chemicals or chemical residue. In some implementations, the sensors 128 may be configured to generate data indicative of one or more of the orientation, attitude, altitude, pressure, temperature, motion, physical location, other data, or any combination thereof.

At 506, the method 500 may include comparing the determined data to previously stored data in a memory 138. The PSU 104 may include a memory 138 that may store the determined data, including image data 144, chemical data 146, and other data that may have been received from one or more of the analytics system 154 or another data source, such as a law enforcement system. The image data 144 may include pictures of missing persons or other persons of interest, such as wanted individuals, suspected terrorists, image data from other facial recognition databases, or any combination thereof. The chemical data 146 may include data related to chemicals that are of interest or that are not permitted on the transport vehicle 102. In some implementations, the data may include pattern data that may include a combination of parameters determined from the data.

At 508, the method 500 may include determining a match. Determining a match by comparing selected data points within the determined data to corresponding data points within the previously stored data in the memory. For example, a processor 136 of the PSU 104 may compare one or more of the optical data or the chemical data to data (image data 144 or chemical data 146) stored in the memory 138. In another example, the processor 136 of the PSU 104 may determine a pattern based on one or more data points (such as temperature, heart rate, chemical data, or other data) and may compare the pattern to one or more previously stored data patterns in the memory 138.

If no match is found at 508, the method 500 may return to 502 to receive one or more signals from the one or more sensors. Otherwise, if a match is found at 508, the method 500 may include generating an alert including data indicative of a match, at 510. The alert may include the determined data as well as the results of the comparison. In an example, the alert may include the optical or chemical data from the sensors 128, data identifying the PSU 104, other data, or any combination thereof.

At 512, the method 500 may including sending the alert to one or more of a computing system of the transport vehicle 102 or an analytics system 154. The PSU 104 may send the alert to the computing system 126 of the transport vehicle 102 via the short-range communication network 122 (within the transport vehicle), to the analytics system 154 through the network 114, to one or more computing devices 124 via the network 122 or via the network 114, or any combination thereof. The short-range communications network 122 may include a local area network, such as an IEEE 802.11 Wi-Fi or wired LAN network, another network, or a combination of networks that is configured to send and receive data using one or more of wired Ethernet connections or radio frequency signals, such as radio frequency signals in a range of about 2.4 GHz to 5 GHz,

In the illustrated example of FIG. 5, the determined data may be compared by the processor 136 of the PSU 104 to stored data (such as image data 334 or stored chemical data 336) in the memory 138 or provided by the analytics system 154. In some implementations, the initial alert including the optical or chemical data and data indicative of the match may be sent to the analytics system 154, which may process the initial alert to determine the reliability of the match. If the analytics system 154 confirms the match with a reliability that is greater than a reliability threshold, the analytics system 154 may send the alert to one or more computing devices 124, to the transport vehicle computing system 126, or any combination thereof.

In other implementations, the PSU 104 may provide the signals or the data determined from the signals from the sensors 128 may be provided to the analytics system 154, and the processor 304 of the analytics system 154 may compare the received data to data (e.g., predetermined threshold data 330, system/device/component data 332, image data 334, chemical data 336, pattern data, other data, or any combination thereof) in the memory 312 to determine the match at 508. If the match is found, the analytics system 154 may generate the alert including the data indicative of the match (at 510) and may send the alert to one or more computing devices 124, to the transport vehicle computing system 126, or any combination thereof.

In some implementations, the PSU 104 described herein may be integrated in onboard systems of a transport vehicle 102, such as an aircraft, and may be configured to provide last mile surveillance related to the monitoring of passengers, passenger items, cargo, or any combination thereof. For example, on departure, airport security may surveil each passenger from the time he or she approaches the airport until the time the door closes on the aircraft. Similarly, airport security may surveil each passenger from the time he or she exits the aircraft until he or she departs the airport. The PSU 104 may provide surveillance functionality on the aircraft and in-flight, covering the “last mile” of the airline services. The sensors 128 may be configured to capture optical data, which may be processed by a GPU (processor 136) within the PSU 104 (or communicated by the PSU 104 via the satellite antennas 118 to a cloud system or to a ground-based system, such as the analytics system 154) for facial recognition functionality. Alternatively, or in addition, the sensors 128 may be configured to capture thermal data associated with each passenger. In some instances, elevated thermal data (above 98.6 degrees Fahrenheit) may be indicative of a fever, which may provide a basis for removal of the passenger to prevent the spread of a contagious disease. The processor 136 of the PSU 104 or the processor 304 of the analytics system 154 may determine the elevated thermal data and may generate an alert to facilitate the removal or quarantine of the passenger.

In some implementations, the sensors 128 may capture optical data that is not visible to the human eye but that includes sufficient contrast information to be differentiated by further processing. Such optical data may include eye movements, transient facial expressions, gestures, or other motion data. In some implementations, the processor 136 of the PSU 104 or the processor 304 of the analytics system 154 may be configured to determine heart rate data or other data based on almost imperceptible changes in skin color or movement of the skin determined from the optical data. Based on such data or on combinations of such data, the processor 136 of the PSU 104 or the processor 304 of the analytics system 154 may determine or infer a person of interest and send an alert to one or more computing devices 124 associated with one or more of onboard personnel or security personnel.

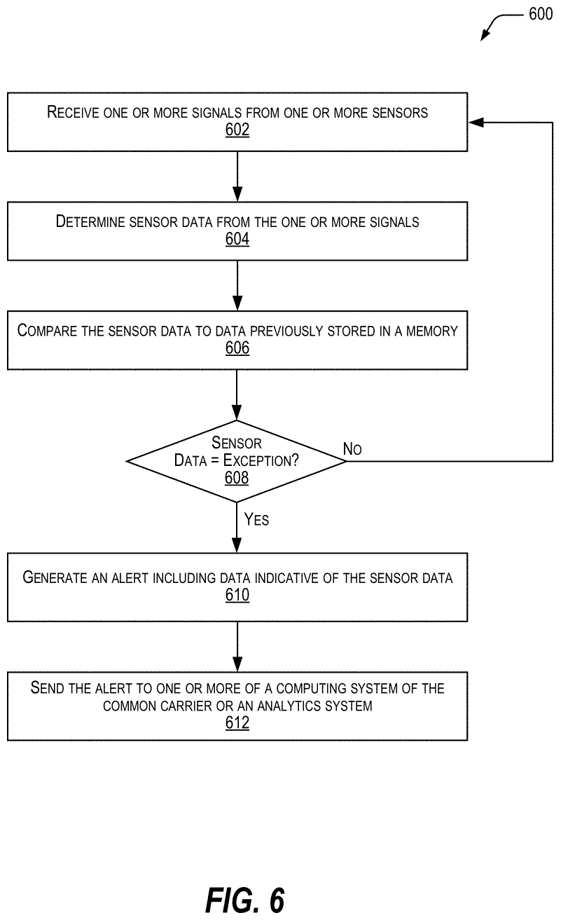

FIG. 6 depicts a flow diagram of a method 600 of determining an alert based on sensor data using a processor 136 of a PSU 104, in accordance with certain embodiments of the present disclosure. At 602, the method 600 may include receiving one or more signals from one or more sensors 128. In some implementations, a PSU 104 may include a processor 136 that is configured to receive signals from the one or more sensors 128, which are associated with passenger areas of a transport vehicle 102, such as an airplane, a ship, a ferry, a train, a commuter bus, or another form of public transportation. Alternatively, data related to the signals from the sensors 128 may be provided to the analytics system 154.

At 604, the method 600 may include determining sensor data from the one or more signals. In some implementations, the sensor data may include optical data, chemical data, temperature data, radiation data, pressure data, other data, or any combination thereof, and the processor 136 of the PSU 104 may compare the sensor data to other data, such as images, chemicals, patterns, or thresholds. In some implementations, the processor 304 of the analytics system 154 may determine the sensor data.

At 606, the method 600 may include comparing the sensor data to data previously stored in a memory 138. In some implementations, the data previously stored in the memory 138 may include one or more thresholds (threshold data 330). In some implementations, the sensor data may include temperature data or radiation data. In other implementations, the sensor data may include optical data, which may be compared to patterns of data, images, or combinations of data points. In some implementations, a processor of the PSU 104 or of the analytics system 154 may be configured to determine reliability data corresponding to a determined pattern, a determined measurement, a determined comparison, and so on. The processor may then use the reliability data (from a match or a threshold comparison) to determine whether or not to trigger an exception.

At 608, the method 600 may include determining if the sensor data equals an exception. An exception may be determined when the sensor data exceeds a threshold or matches a pattern stored in the memory 138 within a margin of error that is less than a threshold error. In some implementations, the determination of an exception may be more complicated that a threshold comparison. For example, the sensors 128 may capture optical data that is not visible to the human eye but that includes sufficient contrast information to be differentiated by further processing by the processor 136 of the PSU 104 or the processor 304 of the analytics system 154. Such optical data may include eye movements, transient facial expressions, gestures, or other motion data, thermal data, and other data. In some implementations, the processor 136 of the PSU 104 or the processor 304 of the analytics system 154 may be configured to determine heart rate data or other data based on almost imperceptible changes in skin color or movement of the skin determined from the optical data. Based on such data or on combinations of such data, the processor 136 of the PSU 104 or the processor 304 of the analytics system 154 may determine or infer a person of interest, triggering and exception.

If the sensor data is does not represent an exception at 608, the method 600 may return to 602 to receive one or more signals from the one or more sensors 128. Otherwise, if the sensor data equals an exception, the method 600 may include generating an alert including data indicative of the sensor data, at 610. The alert may include the sensor data from the sensors 128, data identifying the PSU 104, and so on.

In an example, a passenger entering the transport vehicle 102 may have an elevated temperature. One or more temperature sensors of the one or more sensors 128 may capture the temperature data associated with the passenger, which temperature data may be compared to a temperature threshold. If the temperature data exceeds the temperature threshold, an alert may be generated that a “sick” individual is entering the transport vehicle. In some instances, the alert may be used to notify security to remove the sick individual to prevent contamination of other passengers.

In another example, a passenger entering the transport vehicle 102 or a device being carried by the passenger may emit radioactive energy, which may be detected by one or more radiation sensors of the one or more sensors 128. If the level of the radiation exceeds a threshold level, an alert may be generated that may flag the individual and the type of radiation. Other examples are also possible.

In still another example, the processor of the PSU 104 or the analytics system 154 may determine a pattern from optical data captured by the sensors 128. The pattern may include a facial image, a pattern of changing sensor values over time, a pattern of other optical data, combinations of different types of sensor data, other data, or any combination thereof. The processor of the PSU 104 or the analytics system 154 may generate the alert, at 610, when the pattern matches or corresponds to a predetermined pattern.

In some implementations, the processor (such as a GPU) 136 of the PSU may be configured to receive optical data corresponding to each of a plurality of persons from the one or more sensors 128. The optical data may include images of persons entering a transport vehicle 102. The images may include facial data as well as more specific image data, such as one or more of eye movement data, transient facial expression data, gesture data, other motion data, infrared data, and other data. The sensors 128 may be configured to capture optical data that may be imperceptible to the human eye, but which can be readily determined by the processor 136 based on contrast information. Slight color variations and changes may be determined from the contrast data. Such changes may be indicative of blood flow in capillaries within the person's face, which can be used to determine skin coloration or skin movements. Coloration variations may be used to infer heart rate based on blood flow changes over time or to determine other information. Patterns of such information, over time, may be used to determine characteristics indicative of a potential threat, such as a potential terrorist, a criminal, or other person of interest. In some implementations, the processor 136 may be configured to determine a person of interest from the plurality of persons based on the determined parameters that correspond to one of the patterns of image data changes indicative of the potential threat. Other examples are also possible.

At 612, the method 600 may including sending the alert to one or more of a computing system 126 of the transport vehicle 102, to a computing device 124, to the analytics system 154, or any combination thereof. The alert may include the sensor data that produced the alert, data determined from the sensor data, other data, or any combination thereof. The PSU 104 may send the alert to the transport vehicle computing system 126 via the short-range communication network 122, to the analytics system 154 through the network 114, to one or more computing devices 124 via the network 122 or via the network 114, or any combination thereof.

In the illustrated example of FIG. 6, the sensor data is processed by the processor 136 of the PSU 104. In some implementations, the initial alert, including the sensor data and data indicative of the match or indicative of the sensor data exceeding a threshold, may be sent to the analytics system 154, which may process the sensor data to determine the reliability of the determination. If the analytics system 154 confirms the determination with a reliability that is greater than a reliability threshold, the analytics system 154 may send the alert to one or more computing devices 124, to the transport vehicle computing system 126, or any combination thereof.

In other implementations, the sensor data may be received by the analytics system 154, and the processor 304 of the analytics system 154 may compare the sensor data to one or more of the image data 334, the chemical data 336, or the thresholds 330 in the memory 312. If the match is found or the sensor data exceeds the thresholds, the analytics system 154 may generate the alert including the data indicative of the comparison and may send the alert to one or more computing devices 124, to the transport vehicle computing system 126, or any combination thereof.

FIG. 7 depicts a graphical interface 700 that may be provided by an analytics system 154 based on data from an on-board PSU 104, in accordance with certain embodiments of the present disclosure. The graphical interface 700 may include a plurality of user-selectable control options accessible by a user to access or view selected data. In some implementations, the user-selectable control options may include one or more tabs, which may represent categories of information.

The graphical interface 700 may include an “Active Alerts” tab 702, an “All Alerts” tab 704, a “Maintenance Schedule” tab 706, an “Other” tab 708, and a “Settings” tab 710. The tabs 702, 704, 706, 708, and 710 are provided for illustrative purposes only, and are not intended to be limiting. The tabs 702, 704, 706, 708, and 710 may represent categories of information, and the user may access the associated information by selecting one of the tabs.

In this example, the user has selected the “Active Alerts” tab 702, which caused the graphical interface 700 to display a user-selectable list 712 of active alert issues. The graphical interface 700 is configured to present information from multiple PSUs 104 that are integrated on aircraft transport vehicles 102. The active alert issues in the list 712 may correspond to flights using airplane transport vehicles 102 with integrated PSUs 104 that reported an alert or that reported sensor data that caused the analytics system 154 to determine the alert. In this example, the list includes links to data associated with a first airline flight number XX 1111 and a second airline flight number YY 2222. The user has selected (as indicated by the dashed box) flight number YY 2222, which reported an in-flight maintenance issue at 8:45 AM EST.

In response to selection of the flight from the list 712, the graphical interface 700 may present a data panel 714, which may include text, images, maintenance indicators, other data, or any combination thereof. In this example, the data panel 714 may include a text explanation 716 of the alert data. In this example, the text explanation explains that

“Flight Number XX 1111 of XX Airlines detected an issue with Engine #1 at 8:45 am. Sensor data indicated low turbine pressure. Requires engine maintenance at Depot.”

The data panel 714 may also include one or more visualizations of the transport vehicle 102. In this example, the aircraft transport vehicle 102 is shown in a side view 718, a top view 720, and a front view 722. In each view 718, 720, and 722, a component (engine #1) is highlighted or otherwise indicated by a visual indicator 724. In this example, the visual indicator 724 is represented as a dashed box that circumscribes a system, device, or component that is associated with the alert. In other implementations, the visual indicator 724 may be a highlighted object, an arrow, a circle, or another indicator. In this example, the dashed box 724 may provide a visual indicator that may draw the user's attention to a system, device, or component that is associated with the alert. In some implementations, the visual indicator 724 may be a user-selectable element that may be accessible by the user to access further details regarding the alert.

For example, in response to user selection of the visual indicator 724, the graphical interface 700 may display an exploded view or more detailed view of the system, device, or component requiring attention. In this example, selection of the visual indicator 724 by the user may cause the graphical interface 700 to display an exploded view of the engine. The component that caused the alert to be generated may be highlighted within the exploded view.

In conjunction with the systems, methods, devices, and graphical interfaces described above with respect to FIGS. 1-7, a PSU 104 may be integrated within a transport vehicle 102 to couple the antennas for satellite and base station communications and the local area network transceivers to enable in-transit communications between the transport vehicle 102 and other computing devices 124, both within the transport vehicle 102 or through a communications network 114.

In some implementations, each PSU 104 may include a power interface to receive power from a transport vehicle 102, an input/output (I/O) interface 133 configured to receive data from one or more sensors 128 associated with the transport vehicle 102, a first communication interface communicatively coupled to a short-range wireless network hosted by the transport vehicle, and a second communication interface coupled to one or more antennas configured to communicate wirelessly with a network 114 (such as the Internet) through one or more of a base station 110 or a satellite 112. In some implementations, the PSU 104 may attempt to establish a communications link to the analytics system 154 through the second communication interface. When the communications link is established, the PSU 104 may send the captured data to the analytics system.

The PSU 104 may include a processor (such as a graphics processing unit) 136 configured to receive sensor data from the one or more sensors 128. The processor 136 may process the sensor data to determine an alert event. Such an event may include a pressure that is below a threshold pressure; a temperature that is greater than a threshold temperature; a chemical signature that matches a prohibited, dangerous, or unusual chemical; an optical facial recognition match to a stored image of a person of interest; and so on. The processor 136 may be configured to generate an alert based on the comparison. The PSU 104 may send the alert to one or more of a computing device 124, a transport vehicle computing system 126, or an analytics system 152.

In some implementations, in addition to supplying power to one or more components of a communications system of a transport vehicle, a PSU 104 may include a processor 136 that may receive sensor data from one or more sensors 128 associated with passengers entering or moving within the transport vehicle 102 as well as sensor data related to one or more systems, devices, or components of the transport vehicle 102. For example, the processor 136 may receive sensor data associated with one or more of the engines, doors, control systems, bathrooms, components, and so on. The sensor data may include image data, temperature data, chemical data, radiation data, pressure data, other data, or any combination thereof.

The PSU 104 may provide an advantage over external safety or security systems because the PSU 104 is hardwired within the communications system of the transport vehicle 102 and coupled to integrated sensors and systems. In an example, while transport vehicles 102 may include a first tier of passenger review (such as the transportation security administration (TSA), metal detectors, or other security measures) prior to the passenger entering the transport vehicle, the PSU 104 may provide a secondary security check that may be configured to determine passengers from optical data, passenger health issues from temperature data, chemical contamination from chemical data, radiological contamination from radiation data, and so on and may continue to monitor the passengers during transit. The PSU 104 may perform detection operations and may generate an alert when the PSU 104 based on the sensor data.

Additionally, the PSU 104 may monitor systems and devices of the transport vehicle 102 during transit, which may enable a rapid response and repair when the transport vehicle 102 reaches a depot. In some implementations, the PSU 104 may utilize the data over time to predict or determine service intervals. Other implementations are also possible.

Although the present invention has been described with reference to preferred embodiments, workers skilled in the art will recognize that changes may be made in form and detail without departing from the scope of the invention.

What is claimed is:

1. A power supply unit comprising:
a power supply interface configured to receive a power supply from a transport vehicle;
a first interface coupled to one of the one or more power supply buses and communicatively coupled to a short-range communications network associated with the transport vehicle;
a second interface coupled to one or more radio frequency antennas configured to communicate with one or more of a satellite or a base station;
an input/output (I/O) interface coupled to one or more sensors; and
a graphics processing unit (GPU) coupled to the power supply interface, the first
interface, the second interface, and the I/O interface, the GPU configured to receive data from the one or more sensors, determine an alert based on the received data, and send the alert to one or more computing devices via one or more of the first interface or the second interface.

2. The power supply unit of claim 1, wherein the power supply interface comprises a power management unit configured to control power provided to the first interface, the second interface, the I/O interface, and the GPU.

3. The power supply unit of claim 1, wherein the one or more radio frequency antennas are configured to send and receive data using a range of frequencies from 12 to 18 gigahertz (GHz) defining a Ku Band.

4. The power supply unit of claim 1, wherein the one or more radio frequency antennas are configured to send and receive data using a range of frequencies from 26.5 to 40 gigahertz (GHz) defining a Ka Band.

5. The power supply unit of claim 1, wherein the one or more radio frequency antennas are configured to send and receive data using a range of frequencies from 18 to 27 gigahertz (GHz) defining a K Band.

6. The power supply unit of claim 1, further comprising:
a memory configured to store image data including images of persons; and
wherein the GPU is configured to:
receive optical data from the one or more sensors;
compare portions of the optical data to the images in the memory using facial recognition to determine a match; and
determine the alert in response to determining the match.

7. The power supply unit of claim 6, wherein the images of persons include images of one or more of missing persons or persons of interest previously reported to or by a law enforcement agency.

8. The power supply unit of claim 1, wherein the GPU is configured to:
receive thermal data from the one or more sensors, the thermal data including a thermal scan of each person entering the transport vehicle;
compare the thermal data to one or more temperature thresholds; and
determine the alert when the thermal data exceeds one or more of the temperature thresholds.

9. The power supply unit of claim 1, wherein:
the one or more sensors include one or more of a chemical sensor or a radiation sensors configured to produce contamination data; and
the GPU is configured to determine the alert when the contamination data exceeds one or more thresholds.

10. The power supply unit of claim 1, further comprising:
a memory configured to store image data including patterns of image data changes indicative of a potential threat; and
wherein the GPU is configured to:
receive optical data corresponding to each of a plurality of persons from the one or more sensors, the optical data including one or more of eye movement data, transient facial expression data, gesture data, other motion data, infrared data, and other data;
determine contrast information within the optical data;
determine one or more parameters associated with each person of a plurality of persons based changes in skin coloration or skin movements determined from the optical data and the contrast information; and
determine a person of interest from the plurality of persons based on the determined one or more parameters that correspond to one of the patterns of image data changes indicative of the potential threat.

11. A power supply unit comprising:
a power supply interface configured to receive a power supply from a transport vehicle, the power supply interface including a power management unit;
a first interface communicatively coupled to a short-range communications network associated with the transport vehicle;
a second interface coupled to one or more radio frequency antennas configured to communicate with one or more of a satellite or a base station;
an input/output (I/O) interface coupled to one or more sensors;
a graphics processing unit (GPU) coupled to the power supply interface, the first interface, the second interface, and the I/O interface, the GPU configured to receive data from the one or more sensors, determine an alert based on the received data, and send the alert to one or more computing devices via one or more of the first interface or the second interface; and
wherein the power supply interface comprises a power management unit configured to control power provided to the first interface, the second interface, the I/O interface, and the GPU.

12. The power supply unit of claim 10, wherein the one or more radio frequency antennas are configured to send and receive data using one or more ranges of frequencies including a first frequency range from 12 to 18 gigahertz (GHz) defining a Ku Band, a second frequency range from 18 to 27 GHz defining a K Band, or a third frequency range from 26.5 to 40 GHz defining a Ka Band.

13. The power supply unit of claim 11, wherein:
the one or more sensors include one or more of a chemical sensor or a radiation sensors configured to produce contamination data; and
the GPU is configured to determine the alert when the contamination data exceeds one or more thresholds.

14. The power supply unit of claim 11, further comprising:
a memory including stored images of persons; and
wherein the GPU is configured to:
receive optical data from the one or more sensors;
compare portions of the optical data to the stored images in the memory to determine a match; and
determine the alert in response to determining the match.

15. The power supply unit of claim 14, wherein the images of persons include images of one or more of missing persons or persons of interest previously reported to or by a law enforcement agency.

16. The power supply unit of claim 11, wherein the GPU is configured to:
receive thermal data from the one or more sensors, the thermal data including a thermal scan of each person entering the transport vehicle;
compare the thermal data to one or more temperature thresholds; and
determine the alert when the thermal data exceeds one or more of the temperature thresholds.

17. The power supply unit of claim 11, wherein the one or more computing devices comprise one or more of a smartphone or an interface of a computing system integrated within the transport vehicle.

18. A method comprising:
receiving signals from one or more sensors at a power supply unit (PSU) coupled to a transport vehicle, the signals corresponding to one or more parameters measured at one or more passageways of the transport vehicle;
determining sensor data from the received signals using a graphical processing unit (GPU) of the PSU;
comparing, using the GPU, the sensor data to one or more of image data, temperature data, chemical data, or radiation data stored in a memory of the PSU;
selectively generating an alert using the GPU based on the comparison; and
sending the alert to one or more computing devices via one or more of a first interface or a second interface, the first interface communicatively coupled to a short-range communications network associated with the transport vehicle, the second interface coupled to one or more radio frequency antennas configured to communicate with one or more of a satellite or a base station using one or more of a first range of frequencies from 12 to 18 gigahertz (GHz) defining a Ku Band, a second range of frequencies from 18 to 27 GHZ defining a K Band, or a third range of frequencies from 26.5 to 40 gigahertz (GHz) defining a Ka Band.

19. The method of claim 18, wherein:
the sensor data includes captured image data of persons entering the transport vehicle; and
the method comprises:
comparing, using the GPU, the captured image data to the image data stored in the memory, the image data stored in the memory includes images of one or more of missing persons or persons of interest previously reported to or by a law enforcement agency; and
selectively generating the alert when the captured image data matches the image data in the memory.

20. The method of claim 18, wherein:
the sensor data includes one or more of thermal data, chemical data, or radiation data; and
the method comprises:
comparing the sensor data to one or more thresholds; and
determining the alert when the sensor data exceeds one or more of the thresholds.
